(19) United States
(12) Patent Application Publication
(10) Pub. No.: US 2016/0016324 A1
(43) Pub. Date: Jan. 21, 2016

(54) METHOD FOR ADJUSTING THE RADIAL GAP BETWEEN TWO TOOLS, CONVERTING ARRANGEMENT FOR A SUBSTRATE, CASSETTE, UNIT AND A MACHINE PROVIDED THEREWITH

(71) Applicant: BOBST MEX SA, Mex (CH)

(72) Inventors: Sylvain BAPST, Bulle (CH); Guillaume DÉNISSE, Féternes (FR)

(73) Assignee: BOBST MEX SA, Mex (CH)

(21) Appl. No.: 14/772,851

(22) PCT Filed: Mar. 4, 2014
(86) PCT No.: PCT/EP2014/000545

§ 371 Date: Sep. 4, 2015

(30) Foreign Application Priority Data
Mar. 7, 2013 (EP) 13001151.3

(51) Int. Cl. B26D 7/26; B31F 1/10; B26F 1/38

(52) U.S. Cl. CPC B26D 7/265; B26F 1/384; B31F 1/10

(57) ABSTRACT

A method for adjusting a radial gap (20) between two parallel rotary tools (16, 17) used for converting a flat substrate (2), the method using a converting arrangement (18) including a first and a second cylindrical rotary converting tool (16, 17), each tool provided with two laterally spaced apart conical lateral rolling rings (21, 22, 23, 24) arranged to cooperate to convert the substrate (2); a first and a second lateral bearing (26, 27), holds the first tool (16) for rotation (Rs); a third and a fourth lateral bearing (29, 31), holds the second tool (17) for rotation (Ri); clamping elements (34, 37) tighten the first to the third bearing (26, 29) and the second to the fourth bearing (27, 31). The method steps include loosening the elements for tightening (34, 37); pushing (U) the first bearing (26) away from the third bearing (29), and the second bearing (27) away from the fourth bearing (31) along a predetermined distance (e); modifying (L) a lateral position of at least one of the rings (21, 22); moving (D) the first bearing (26) radially closer to the third bearing (29), and the second bearing (27) radially closer to the fourth bearing (31), and retightening the elements for tightening (34, 37).

### CROSS-REFERENCE TO RELATED APPLICATIONS

The present application is a 35 U.S.C. §§371 national phase conversion of PCT/EP2014/000545, filed Mar. 4, 2014, which claims priority of European Application No. 13001151.3, filed Mar. 7, 2013, the contents of which are incorporated by reference herein. The PCT International Application was published in the French language.

The present invention concerns a method for adjusting the radial gap existing between two tools for converting a flat substrate. The invention relates to a converting arrangement for a flat substrate, the arrangement provided with two cylindrical converting tools, in a machine for producing packaging. The invention also relates to a converting cassette for a flat substrate, comprising a converting arrangement for the flat substrate. The invention concerns a converting unit for a flat substrate, provided with a converting cassette for the flat substrate. The invention concerns a converting unit for a flat substrate, comprising at least one converting arrangement for the flat substrate. The invention also concerns a machine for producing packaging from a flat substrate, comprising at least one converting unit for the flat substrate.

### TECHNICAL BACKGROUND

A machine for producing packaging is intended for the manufacture of boxes which form the packaging, after folding and gluing of the boxes. In the machine, an initial flat substrate, such as a continuous web of cardboard, is unwound and is printed by a printing machine, which is made up of printer groups. The web is then transferred into a converting unit, in order to make plate elements, in this case boxes.

The converting unit comprises at least one converting arrangement provided with two cylindrical rotary tools, which are positioned parallel to one another so as to cooperate. The web circulates between the two tools in order to be converted there. The two tools turn in respective opposite directions. The first tool is rotatably mounted in first and second spaced apart bearings and the second tool is rotatably mounted in third and fourth spaced apart bearings. Tightening elements maintain firmly together and prestress the first and the third bearings and also the second and the fourth bearings. Most of time, the converting arrangement forms a cassette. The cassette is inserted by sliding it into each of the lateral supporting frames of the unit.

The cassette allows the tools to be changed quickly, in terms of the conversions of the substrate to be carried out. The packaging manufacturer has at least two cassettes. A first cassette is in the machine currently operating and is configured and adapted in terms of the current converting job. During this time, a second cassette is in the process of being assembled and adjusted so as to be adapted and configured in terms of the following converting job. When the job is changed, the operator takes out the old cassette and inserts the new cassette, reducing the time the machine is stopped to a minimum.

For example, one of the arrangements or one of the cassettes is a rotary cutting arrangement or a rotary cutting cassette respectively. A first cylindrical cutting tool is provided with knifes, and a second cylindrical tool is smooth and is called an anvil. A radial gap between the first cylindrical cutting tool and the second cylindrical tool has to be adjusted in a very precise manner.

At the moment of the cut, the edges of the knives of the cutting tool must pass as close as possible to the anvil cylinder so as to carry out a clean cut. The edges of the knives, however, must not touch the anvil cylinder as they would be irretrievably destroyed during rotation. The constituent material of the substrate, i.e. the fibers in the case of cardboard, must not appear at the cut. Neither is it desirable to have dust originating from the cut in the constituent material of the substrate. The point of adjusting the radial gap is also to compensate for the progressive wear on the knifes of the cutting tool. This is why the optimum radial gap between the two cylindrical rotary tools is adjusted to the micron.

### Prior art

Document EP-0'764'505 describes a cutting station where each end of the two cylindrical rotary tools comprises a conical lateral rolling ring. The two rings of the first tool roll along the two rings, which are associated and diametrically opposed, of the second tool respectively. Each of the rings has a truncated form, with an inclined surface which comes into contact with the inclined surface of the directly associated ring. The position of the rings of the first tool is able to be modified laterally. The lateral displacement of a ring with respect to its associated ring brings about a variation in the overall thickness of the two rings together. This varies the space between the first and the second tools, so that the radial gap is obtained in a precise manner.

To do this, the operator initially loosens the elements for tightening the bearings. Then he displaces the assembly formed by the first bearing, the second bearing and the first tool so as to move it away from the assembly formed by the third bearing, the fourth bearing and the second tool respectively. This displacement is provided by pivoting adjusting wedges mounted on micrometer screws.

However, the solution takes a long time. Each of the wedges has to be turned manually and in a sequential manner, which takes time. Another disadvantage is that it is difficult to displace the first and the second bearings in a simultaneous manner and over the same distance. Often, the first bearing is lifted being skewed with respect to the second bearing.

### SUMMARY OF THE INVENTION

A main objective of the present invention is to implement a method of adjustment for an arrangement intended to convert a flat substrate. A second objective consists in providing a method allowing an adjustment of the radial gap existing between two converting tools for a flat substrate to be facilitated. A third objective is to perfect a converting arrangement for a flat substrate, intended for a converting unit in a machine producing packaging. A fourth objective is to realize a converting arrangement with rotary tools allowing simplified adjustment to be obtained and the time taken to adjust the radial gap between the two tools to be reduced. A fifth objective is to resolve the technical problems mentioned for the arrangements of the prior art. A sixth objective consists in providing a cassette comprising a converting arrangement for the converting unit. Yet another objective is succeeding in inserting a converting unit into a machine for producing packaging.

A method is used to adjust a radial gap existing between two tools for converting a flat substrate, in a converting arrangement for the flat substrate. The converting arrangement for the flat substrate comprises a first cylindrical rotary converting tool and a second cylindrical rotary converting tool. Each of the first and the second cylindrical rotary converting tools is provided with two conical lateral rolling rings respectively. The first cylindrical and the second cylindrical rotary converting tools are arranged together and cooperate to convert the substrate. The converting arrangement for the flat substrate comprises a first lateral bearing and a second lateral bearing which hold the first cylindrical rotary converting tool for rotation. The converting arrangement for the flat substrate also comprises a third lateral bearing and a fourth lateral bearing which hold the second cylindrical rotary converting tool for rotation. The converting arrangement for the flat substrate comprises elements for tightening the first lateral bearing to the third lateral bearing and elements for tightening the second lateral bearing to the fourth lateral bearing.

In accordance with one aspect of the present invention, the method comprises the steps of:
loosening the elements for tightening the first lateral bearing to the third lateral bearing,
loosening the elements for tightening the second lateral bearing to the fourth lateral bearing
pushing the first lateral bearing away from the third lateral bearing, along a predetermined distance, and leaning on the third lateral bearing,
pushing the second lateral bearing away from the fourth lateral bearing, along a predetermined distance, and leaning on the fourth lateral bearing,
modifying a lateral position of at least one of the conical lateral rolling rings on at least one of the cylindrical rotary converting tools,
moving the first lateral bearing closer to the third lateral bearing,
moving the second lateral bearing closer to the fourth lateral bearing,
retightening the elements for tightening the first lateral bearing to the third lateral bearing, and
retightening the elements for tightening the second lateral bearing to the fourth lateral bearing.

In other words, in one stage, the first bearing is pushed to move it away from the third bearing, and the second bearing is pushed to move it away from the fourth bearing. The stages that consisting in pushing and moving the corresponding bearings away or closer are each effected simultaneously and in one single action. With such stages for pushing away in one stage, adjustment are simpler, which thus allows operator errors to be avoided. As a result, adjustment time is reduced.

The flat substrate is defined, for example, as a material in a continuous web, such as paper, flat cardboard, corrugated cardboard, glued corrugated cardboard, flexible plastic, for example polyethylene (PE), polyethylene-terephthalate (PET), bioriented polypropylene (BOPP) or yet other materials.

A converting arrangement for a flat substrate comprises a first cylindrical rotary converting tool and a second cylindrical rotary converting tool. Those tools are arranged together and cooperate together to provide conversion of the flat substrate. The converting arrangement for the flat substrate comprises a first lateral bearing and a second lateral bearing which respectively hold the first cylindrical rotary converting tool for rotation. The converting arrangement for the flat substrate also comprises a third lateral bearing and a fourth lateral bearing which hold the second cylindrical rotary converting tool for rotation.

In another aspect of the invention, the converting arrangement for the flat substrate comprises translation means to move apart in a radial direction over a predetermined distance, and conversely in order to move closer, the first lateral bearing from/to the third lateral bearing, and the second lateral bearing from/to the fourth lateral bearing, between two positions, a first position moved closer in which the two cylindrical rotary converting tools cooperate, and a second position moved apart in which the two cylindrical rotary converting tools are capable of being modified, so as to adjust a radial gap between the first cylindrical rotary converting tool and the second cylindrical rotary converting tool.

Expressed another way, the translation means are of an on-off type. An operator moves the translation means between the off and on positions. With the translation means in the on position, the first lateral bearing and the third lateral bearing are moved apart from the second lateral bearing and from the fourth lateral bearing, respectively. The two tools are therefore also moved apart from one another, which allows an operator to intervene in order to modify the tools easily and to adjust them as a result. When the translation means are in the off position, the tools are once again in the operating state.

In another aspect of the invention, a converting cassette for a flat substrate comprises a converting arrangement for the flat substrate which has one or several of the technical characteristics described above. The converting cassette makes access, assembly and disassembly of the tools easier for the operator carrying out the adjustments and maintenance of the unit and of the machine.

According to another aspect of the invention, a converting unit for a flat substrate is provided with at least one converting cassette for the flat substrate. The cassette is provided with a converting arrangement for the flat substrate, having one or several of the technical characteristics described above.

According to another aspect of the invention, a converting unit for a flat substrate comprises at least one converting arrangement for the flat substrate, having one or several of the technical characteristics described above and claimed.

According to another aspect of the invention, a machine for producing packaging from a flat substrate comprises at least one converting unit for the flat substrate, having one or several of the technical characteristics described above and claimed.

### BRIEF DESCRIPTION OF THE DRAWINGS

The invention will be well understood and its diverse advantages and different characteristics will be highlighted better from the following description and from the non-limiting exemplary embodiment, with reference to the accompanying schematic drawings, in which:

FIG. 1 shows a schematic side view of a converting unit;

FIG. 2 shows an isometric view of a cassette provided with a converting arrangement according to the invention;

FIG. 3 shows a partial longitudinal sectional view of two front bearings of the cassette in FIG. 2;

FIGS. 4 and 5 show an enlarged longitudinal sectional view of the translation means with a first position moved closer and a second position moved apart respectively;

FIG. 6 shows a partial isometric view of the actuating means for the translation means.

### DESCRIPTION OF PREFERRED EMBODIMENTS

A machine for producing packaging (not shown) processes a material or a flat substrate. In this case, it is a substrate in the form of a continuous web, for example of flat cardboard. As shown in FIG. 1, the machine comprises a converting unit for a substrate 1 in order to convert the web 2. The direction of feed or of unwinding (Arrow F in FIG. 1) of the web 2 and of the converted web following the longitudinal direction indicates the upstream direction and the downstream direction of the unit 1. The positions front and rear are defined with regard to the cross direction, as being the driver or operator side and the side opposite the driver or operator side respectively.

The machine can have a web unwinder, units such as printing units, means for controlling the quality and the register of the print, a web guiding means and yet other units which are positioned upstream of the unit 1.

The converting unit 1 is a unit for embossing, creasing and cutting. The web 2 arrives in the unit 1 through the upstream transverse side thereof, at a constant speed. An infeed group comprising drive rollers and return rollers for the web 2 is provided at the input to the unit 1. The unit 1 converts the web 2, gradually by embossing it, creasing it and cutting it.

The unit 1 delivers repeats or converted boxes 3, being as a result in embossed, creased and cut flat cardboard. The boxes 3 leave the unit 1 through the downstream transverse side thereof, at the same constant speed.

The boxes 3, prepared in the unit 1, are then separated laterally and longitudinally from one another in a separating station then are received in a receiving station (not shown).

The unit 1 first comprises a first arrangement for providing the embossing 4, arranged upstream, i.e. at the input to the unit 1. The embossing arrangement 4 is provided with the top rotary embossing tool 6, positioned parallel to a bottom rotary embossing tool 7. In the exemplary embodiment, an embossing cassette 8 comprises the embossing arrangement 4.

The unit 1 comprises a second arrangement for providing the creasing 9, disposed downstream of the embossing arrangement 4. The creasing arrangement 9 is provided with a top rotary creasing tool 11, positioned parallel to a bottom rotary creasing tool 12. In the exemplary embodiment, a creasing cassette 13 comprises the creasing arrangement 9.

The unit 1 comprises a third arrangement providing the cutting 14, disposed downstream of the creasing arrangement 9, i.e. at the output of the unit 1. The cutting arrangement 14 is provided with a first top rotary cutting tool 16, positioned parallel to a second bottom rotary cutting tool 17. In the exemplary embodiment, a cutting cassette 18 comprises the cutting arrangement 14.

The arrangements 4, 9 and 14, and thus the cassettes 8, 13 and 18, are placed following one another so that each one realizes its respective conversion, by embossing, creasing and cutting the web 2. A waste stripping tool in the form of a cylinder provided with stripping needles can also be provided in place of the bottom rotary cutting tool 17. Other combinations are possible such as a top cylinder forming both a cutting tool and a creasing tool.

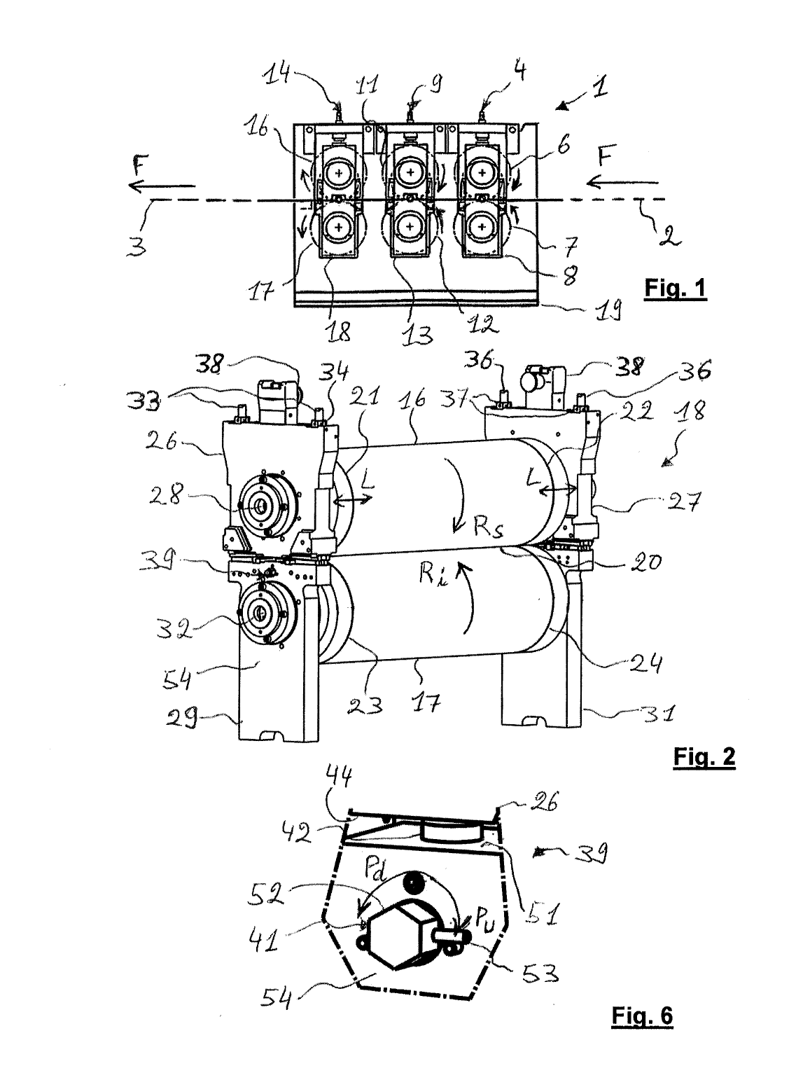

The rotational axis of each of the tools for embossing 6 and 7, creasing 11 and 12 and cutting 16 and 17 is oriented transversely with respect to the unwinding direction F of the web 2. The rotational direction (Arrow Rs in FIG. 2) of the top tools for embossing 6, creasing 11 and cutting 16 is reversed with respect to the rotational direction (Arrow Ri in FIG. 2) of the bottom tools for embossing 7, creasing 12 and cutting 17.

The cassettes for embossing 8, creasing 13 and cutting 18 are capable of being introduced into a supporting structure 19 of the unit 1, of being fixed to the supporting structure 19, of producing, then conversely, are capable of loosened from the positive connection with the supporting structure 19 and of being extracted from the supporting structure 19. The unit 1 thus comprises three transverse housings provided in the supporting structure 19 for each of the three cassettes 8, 13 and 18. The cassettes 8, 13 and 18 are introduced vertically, from above, with respect to the supporting structure 19 into the transverse housings. Conversely, the cassettes 8, 13 and 18 can be removed vertically with respect to the supporting structure 19, out of their respective transverse housings.

The cutting arrangement 14, and therefore the cutting cassette 18, comprises (see FIG. 2) the first top cylindrical rotary tool 16 which is provided with cutter threads (not shown) machined or built on its circumference in terms of the configuration of the boxes to be realized. The second bottom cylindrical rotary tool or anvil 17 has a smooth circumference. The web 2 unwinds F in the radial gap 20 between the top tool 16 and the anvil 17. The top tool 16 is arranged so as to cooperate with the anvil 17 in order to convert, i.e. cut the web 2.

The top tool 16 is provided at its front end with a first front top rolling ring 21. The top tool 16 is provided at its rear end with a second rear top rolling ring 22. The anvil 17 is provided at it front end with a third front bottom rolling ring 23. The anvil 17 is provided at its rear end with a fourth rear bottom rolling ring 24.

All the rings 21, 22, 23 and 24 have a truncated form. The top rings 21 and 22 thus have an inside curved surface laid flat against the curved surface of the top tool 16. The bottom rings 23 and 24 have an inside curved surface laid flat against the curved surface of the anvil 17. The top rings 21 and 22 of the top tool 16 contact, bear on and roll on the opposite bottom rolling rings 23 and 24, respectively of the anvil 17. This results in the front top ring 21 having an outside conical surface which abuts against an outside conical surface of the front bottom ring 23 and the rear top ring 22 having an outside conical surface which abuts against an outside conical surface of the rear bottom ring 24.

In the exemplary embodiment, the two top rings 21 and 22 of the top tool 16 are laterally displaceable (Arrow L in FIG. 2). When the operator displaces laterally L a ring 21 and 22 with respect to its opposite ring 23 and 24, for example by a few tenths of a millimeter, their respective conical surfaces are not positioned in the same place. The overall accumulated thickness of the front ring 21 of the top tool 16 and of the front ring 23 of the anvil 17, or of the rear ring 22 of the top tool 16 and of the rear ring 24 of the anvil 17 vary compared to one another. This results in a variation in the radial space, i.e. in the radial gap 20, between the top tool 16 and the anvil 17.

The cutting arrangement 14, and therefore the cutting cassette 18, comprises a first top front bearing 26 and a second top rear bearing 27, which hold the first tool, i.e. the top tool 16, by its rotational axis 28 for rotation. The cutting arrangement 14, and therefore the cutting cassette 18, comprises a third bottom front bearing 29 and a fourth bottom rear bearing 31 which hold the second tool, i.e. the anvil 17, by it rotational axis 32 for rotation. The base of the two bottom bearings 29 and 31 rests on the supporting structure 19 when the cutting cassette 18 is inserted into the unit 1.

The cutting arrangement 14, and therefore the cutting cassette 18, comprises driving means, in the form of a gear wheel arrangement (not shown in the Figures), intended to rotate the two tools 16 and 17. When the cassette 18 is inserted into the supporting structure 19, the gear wheel arrangement meshes with the teeth of a gear wheel combined with an electric motor for rotational movement.

The first top front bearing 26 of the top tool 16 is fixed to the third bottom front bearing 29 of the anvil 17, and the second top rear bearing 27 of the top tool 16 is fixed to the fourth bottom rear bearing 31 of the anvil 17, so as to constitute the cutting cassette 18. To hold the cassette 18 all in one unit, tightening elements, in the form of four ties, front upstream and front downstream 33, and rear upstream and rear downstream 36, in a vertical manner cross the top front bearing 26 and the top rear bearing 27, on both sides of the rotational axis 28 of the top tool 16. The bottom end of each of the four ties, front 33 and rear 36, is threaded and is screwed into a female thread of the bottom front bearing 29 and of the bottom rear bearing 31 respectively. Four nuts, front upstream and front downstream 34, and rear upstream and rear downstream 37, are screwed onto the top end of the four ties, front 33 and rear 36, respectively. The nuts 34 and 37 block the ties 33 and 36 by bearing on a top face of the top front bearing 26 and of the top rear bearing 27 respectively and allowing the bearings to be prestressed in twos.

The cutting cassette 18, as well as the embossing cassette 8 and the creasing cassette 13, comprise two gripping lugs 38 each provided on the top face of the top front bearing 26 and of the top rear bearing 27. The two lugs 38 are intended for cooperating with the lifting means in order to raise the cassette 18, 8 and 13 vertically and transport it outside of the supporting structure 19.

So as to be able to carry out an adjustment of the radial gap 20 between the top tool 16 and the anvil 17, just one top ring or more often the two top rings 21 and 22 have to be displaced along their tool 16. To do this, the top tool 16 is moved vertically away from the anvil 17, and the rings 21, 22, 23 and 24 are thus freed from any constraint of support.

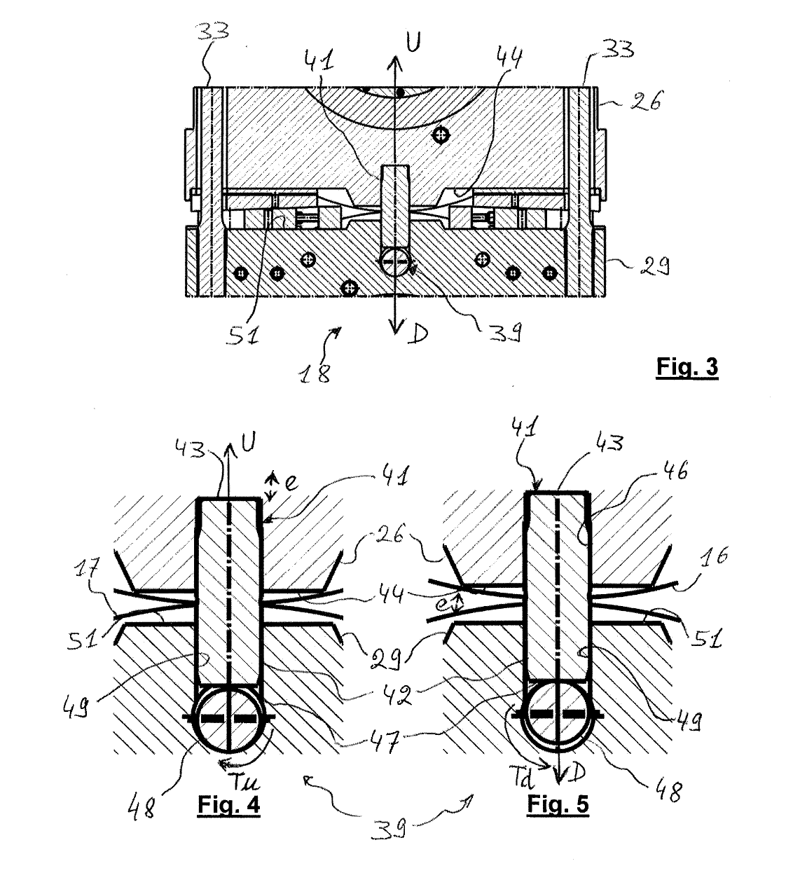

According to the invention, the cutting arrangement 14, and therefore the cutting cassette 18, comprises first translation means 39 in order to move the first bearing 26 vertically away (Arrow U in FIGS. 3 and 4) from the third bearing 29, and conversely in order to move the first bearing 26 vertically closer (Arrow D in FIGS. 3 and 5) to the third bearing 29. The cutting arrangement 14, and therefore the cutting cassette 18, comprises second translation means in order to move the second bearing 27 vertically away from the fourth bearing 31, and conversely in order to move the second bearing 27 vertically closer to the fourth bearing 31. The first and second means of translation 39 move the first bearing 26 and the second bearing 27 respectively along a predetermined distance.

The means of translation 39 have two positions (FIGS. 4 and 5). Consequently, the first and second bearings 26 and 27 have the same two positions and, consequently, the top tool 16 and the anvil 17 have the same two positions. In a first position moved closer, the two tools 16 and 17 are arranged with respect to one another with an optimum radial gap 20, and cooperate to realize the cutting function. In a second position moved away, the two tools 16 and 17 have a space between them and are capable of being modified by displacement of their rings 21 and 22 respectively.

The translation means 39 are advantageously disposed between the first lateral bearing 26 and the third lateral bearing 29 so as to lift up the first lateral bearing 26. The translation means 39 are advantageously disposed between the second lateral bearing 27 and the fourth lateral bearing 31 so as to lift up the second lateral bearing 27.

To do this, the translation means 39, in a preferred manner, are in the form of a first front device 41, in order to move the first bearing 26 away from the third bearing 27 by lifting, and conversely in order to move the first bearing 26 closer to the third bearing 27 by lowering. The translation means 39, in a preferred manner, are in the form of a second rear device, in order to move the second bearing 27 away from the fourth bearing 31 by lifting, and conversely in order to move the second bearing 27 closer to the fourth bearing 31 by lowering.

In the embodiment, the device 41 comprises a cylindrical rod 42 which is vertical, approximately parallel to the front ties 33 and centered with respect to the rotational axis 28 of the top tool 16 and with respect to the rotational axis 32 of the anvil 17. The rod 42 is capable of sliding along a rectilinear vertical movement U and D, between the position moved closer and the position moved away and conversely between the position moved away and the position moved closer. The rod 42 carries out a maximum run (e in FIG. 4) of sliding U. The rod 42 thus reaches a high point which corresponds to the desired and necessary gap between the top tool 16 and the anvil 17 so as to carry out the displacement of the two top rings 21 and 22.

One end or one top face 43 of the rod 42 abuts in an overall manner against a bottom face 44 of the first bearing 26. A first obstructed, vertical, cylindrical housing 46 is arranged in a bottom part of the first bearing 26 and opens out at the bottom face 44 of said first bearing 26. The bottom part of the rod 42 with the top end 43 is thus inserted into the first housing 46.

In a preferred manner, the device 41 comprises an eccentric 48, positioned at the third bearing 29. In order to obtain the sliding movement U and D, an end or a bottom face 47 of the rod 42 can bear on the eccentric 48. A second cylindrical housing 49 is arranged in a top part of the third bearing 29 and opens out at the top face 51 of said third bearing 29. The bottom part of the rod 42 with the bottom end 47 is inserted into the second housing 49. The eccentric 48 is inserted to the bottom of the second housing 49.

The rod 42 is capable of being actuated manually, by rotating the eccentric 48. The eccentric 48 is capable of turning (Arrows Tu and Td in FIGS. 4 and 5) in a perpendicular manner with respect to the rod 42 and to the third bearing 29, i.e. in this case horizontally. The device 41 comprises means for manually actuating the rod 42. Said means comprise a shaft which is appreciably horizontal and extends the eccentric 48 and a rotary actuating knob 52 which is provided with a finger 53, extending out of the outside face 54 of the third bearing 29, and fixed to the shaft of the eccentric 48. The rear device comprises the same constituent parts.

According to the invention, a method for adjusting a radial gap 20 existing between two converting tools, the top tool 16 and the anvil 17, in the converting arrangement, i.e. for cutting 14 the web 2, comprises several successive stages.

In a first stage, the operator releases the prestress by loosening the tightening elements, i.e. in this case the nuts 34 and 37. The operator actuates the actuating knobs 52 by turning them Pu clockwise by half a turn and the eccentric 48 turns Tu in a corresponding manner (see FIGS. 4 and 6). This causes the rod 42 to slide U upward and the first bearing 26 is directly pushed away along the predetermined distance, i.e. the gap e. In said second stage, the first bearing 26 is pushed away U from the third bearing 29 and the second bearing 27 is pushed away from the fourth bearing 31 along a predetermined distance e. The stage consisting in pushing the first bearing 26 away from the third bearing 29 and the second bearing 27 away from the fourth bearing 31 is implemented with two positions, one position moved closer in which the two tools 16 and 17 cooperate for the converting function, and one position moved away in which the lateral position of the ring or rings 21 and 22 is modifiable.

The displacement U of the first bearing 26 thus creates the gap e between the top tool 16 and the anvil 17 so as to allow the radial gap 20 to be adjusted by subsequent displacement of one ring or of the rings 21 and 22. In a third stage, the operator modifies a lateral position of one ring or of the two rings 21 and 22.

The operator actuates the actuating knob 52 by turning it Pd anticlockwise by half a turn (see FIGS. 5 and 6), and the eccentric 48 turns Td in a corresponding manner. This causes the rod 42 to slide D downward, and the first bearing 26 to move closer. In a fourth stage, the first bearing 26 is moved closer to the third bearing 29 and the second bearing 27 is moved closer the fourth bearing 31. Said displacement U of the first bearing 26 thus moves the top tool 16 closer to the anvil 17, in order to allow the cutting function with the optimum radial gap 20 to be re-established.

In a fifth and last stage, the operator re-establishes a prestress by retightening the tightening elements, i.e. the nuts 34 and 37.

The present invention is not limited to the embodiments described and illustrated. Numerous modifications can be realized without in any way departing from the framework defined by the scope of the set of claims.

1. A method for adjusting a radial gap between two tools configured for converting a flat substrate, in a conversion arrangement for the substrate, said method comprising:
a first and a second cylindrical rotary converting tool, each tool supporting thereon respectively two spaced apart, conical shape, laterally movable, rolling rings and the two rings on each tool are arranged to and cooperate with respective ones of the two rings on the other tool to adjust the radial gap to convert the substrate;
a first and a second bearing which are laterally spaced apart, each holding the first tool for rotation;
a third and a fourth, bearing which are laterally spaced apart each holding the second tool for rotation;
elements for tightening the first bearing toward and to the third bearing and the second bearing toward and to the fourth bearing;
the method comprising steps of:
loosening the elements for being tightened and which are located to control movement apart of the opposing bearings;
pushing the first bearing away from the third bearing, and pushing the second bearing away from the fourth bearing along a predetermined distance;
then modifying a lateral position of at least one of the rings on one of the tools;
moving the first bearing closer to the third bearing, and moving the second bearing closer to the fourth bearing to set the gap; and
retightening the elements for tightening.

2. A method according to claim 1, wherein the steps of pushing the first bearing away from the third bearing, and pushing the second bearing away from the fourth bearing are implemented between two positions, at one position which is moved closer, the two tools cooperate, and at another position is moved apart providing a radial gap permitting the lateral position of the ring or rings to be modified.

3. A converting arrangement for converting a flat substrate, the arrangement comprising:
a first and a second cylindrical, rotary converting tool, wherein the two tools are so arranged and so configured as to cooperate to convert the substrate;
a first and a second lateral bearing, which are laterally spaced apart for holding the first tool for rotation;
a third and a fourth lateral bearing, which are laterally spaced apart for holding the second tool for rotation; and
translation means configured to move apart along a predetermined distance (e), and conversely configured to move closer, for the first bearing from/to the third bearing, and the second bearing from/to the fourth bearing, between two positions, wherein one position is moved closer and in which the two tools cooperate, and another position is moved apart in which the two tools are there capable of being modified to adjust a radial gap between the two tools.

4. An arrangement according to claim 3, further comprising the first tool has two laterally extending and laterally spaced apart conical lateral rolling rings, each with a modifiable lateral position.

5. An arrangement according to claim 3, wherein the translation means are arranged between the first and the third bearing, and between the second and the fourth bearing.

6. An arrangement according to claim 5, further comprising the translation means comprise two devices configured for moving apart, and conversely for moving closer, the first bearing from/to the third bearing and the second bearing from/ to the fourth bearing respectively.

7. An arrangement according to claim 6, further comprising the device comprises a sliding rod supported for rectilinear movement between the position moved closer and the position moved apart.

8. An arrangement according to claim 7, wherein a top end of the rod is configured to bear against a bottom face of the first and the second bearing respectively.

9. An arrangement according to claim 7, further comprising the device comprises an eccentric at the bearing, and a bottom end of the rod bears on the eccentric for moving the rod and moving the bearings apart and together.

10. An arrangement according to claim 7, further comprising the device comprises means for manually actuating the rod.

11. An arrangement according to claim 3, wherein the first tool and the second tool is at least one of a cutting tool and a tool for ejecting waste.

12. A converting cassette for a flat substrate, wherein said cassette comprises a converting arrangement, according to claim 3.

13. A converting unit for a flat substrate, wherein said unit is provided with a converting cassette according to claim 12.

14. A converting unit for a flat substrate, wherein said unit comprises at least one converting arrangement, according to claim 3.

15. A machine for producing packaging from a flat substrate, wherein said machine comprises a converting unit, according to claim 13.
